(19) United States
(12) Patent Application Publication
(10) Pub. No.: US 2004/0141137 A1
(43) Pub. Date: Jul. 22, 2004

(54) Electro-optical device, method of manufacturing the same, and electronic apparatus

(75) Inventor: Yukiya Hirabayashi, Suwa-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/658,765

(22) Filed: Sep. 10, 2003

(30) Foreign Application Priority Data
Sep. 17, 2002 (JP) 2002-270503
Sep. 17, 2002 (JP) 2002-270504

(51) Int. Cl. G02F 1/1345

(52) U.S. Cl. 349/149

(57) ABSTRACT

An electro-optical device includes an active matrix substrate having on the same plane a plurality of scanning lines, a plurality of signal lines provided to intersect the scanning lines, a plurality of pixel electrodes provided at the intersection portions of the scanning lines and the signal lines, and a peripheral driving circuits to matrix drive the pixel electrodes; a counter substrate having a common electrode on one surface and facing the active matrix substrate so that the common electrode is opposite to the pixel electrodes; and a liquid crystal layer interposed between the active matrix substrate and the counter substrate. In the common electrode, a portion, where the common electrode overlaps with the peripheral driving circuit or with wiring lines to supply signals to the peripheral driving circuit in plan view, is removed. Furthermore, the counter substrate may be arranged not to be overlapped, in plan view, with the peripheral driving circuit or with the wiring lines to supply signals to the peripheral driving circuit.

### BACKGROUND OF THE INVENTION

1 Field of Invention

The present invention relates to a driving circuit built-in type electro-optical device in which a peripheral driving circuit for matrix driving pixel parts is formed integrally on an active matrix substrate. The invention also relates to a method of manufacturing the same, and an electronic apparatus.

2. Description of Related Art

In an active matrix substrate used for a related art electro-optical device, such as a liquid crystal device, a driving circuit built-in type can be provided in which a peripheral driving circuit, such as a scanning line driving circuit or a data line driving circuit, to drive pixel parts, is formed on the substrate. In such a type of electro-optical driving circuit, components of the peripheral driving circuit and switching elements to drive pixel parts are manufactured by the same process. For example, the components of the peripheral driving circuit in the liquid crystal device are formed simultaneously with thin film transistors (hereinafter “TFTs”) driving the pixel parts. Thus, as compared with forming the driving circuit on another substrate and mounting it on a main substrate, it becomes more advantageous to miniaturize the device and to reduce manufacturing costs.

In the aforementioned liquid crystal device, the active matrix substrate is bonded to a counter substrate by a sealing material, in which spacers are dispersed to keep the gap between the substrates constant, and liquid crystal is injected into a space that is formed between the pair of substrates and the sealing material, and then the space is sealed.

On this counter substrate, a common electrode made of, for example, ITO is formed on the overall inner surface thereof (liquid crystal side). The sealing material is provided in a frame shape around the circumference of this counter substrate. On the inner surface of the active matrix substrate, scanning lines and signal lines are formed in a matrix, and the pixel parts composed of TFTs and pixel electrodes are formed at the intersection portions of the scanning lines and the signal lines. A rectangular display region is configured by a region where these pixel parts are formed in a matrix shape.

In addition, in the peripheral portions of this display region, a peripheral driving circuit, such as a scanning line driving circuit to sequentially supply scanning signals in pulses to each scanning line or a data line driving circuit to supply predetermined image signals to each signal line, is arranged around the circumference of the rectangular display region. The data line driving circuit includes a horizontal shift register to select a predetermined signal line, and a sample hold circuit to supply a sampled image signal to the selected signal line. When the scanning line driving circuit and the horizontal register select a predetermined scanning line and a signal line, respectively, an image signal is supplied to the pixel part located at the intersection portion of the selected line. The aforementioned device is disclosed, for instance, in Japanese Unexamined Patent Application Publication No. 8-248405 or Japanese Unexamined Patent Application Publication No 11-109408

However, as the above-stated scanning driving circuit or data line driving circuit is generally driven at a frequency of several MHz, almost no problem occurs in terms of parasitic capacitance formed between the common electrode on the counter substrate and the peripheral driving circuit on the active matrix substrate or various wires to supply signals to the peripheral driving circuit. That is, even if a signal delay occurs due to such parasitic capacitance, the delay time is sufficiently shorter than a signal writing time. Thus, there is little possibility for the distortion of an image signal to occur.

With respect to above, in the related art, to obtain a higher display quality, high speed driving at about tens of MHz is required for the peripheral driving circuit. In this case, since the writing time is not sufficiently longer than the delay time, the distortion of the image signal may occur due to the parasitic capacitance, which degrades the display quality.

### SUMMARY OF THE INVENTION

The present invention addresses the problems described above, and provides an electro-optical device, a method of manufacturing the same, and an electronic apparatus which reduce or prevent the distortion of the image signal under high speed driving.

A first aspect of the present invention relates to an electronic-optical device including: an active matrix substrate having on the same plane a plurality of scanning lines, a plurality of signal lines provided to intersect the scanning lines, a plurality of pixel electrodes provided at the intersection portions of the scanning lines and the signal lines, and a peripheral driving circuit to matrix drive the pixel electrodes; a counter substrate having a common electrode on one surface and facing the active matrix substrate such that the common electrode is opposite to the pixel electrodes; and a liquid crystal layer interposed between the active matrix substrate and the counter substrate. A portion, where the common electrode overlaps with the peripheral driving circuit or with wiring lines to supply signals to the peripheral driving circuit in plan view, is removed.

According to the present invention, the generation of parasitic capacitance between the peripheral driving circuit and the common electrode is reduced or prevented in advance. Thus, it is possible to reduce the distortion of a signal and to obtain a high quality display even if the peripheral driving circuit is driven at a high speed. In addition, since the generation of the parasitic capacitance is reduced or prevented only by removing the common electrode in the portion facing the peripheral driving circuit, the degree of freedom of the alignment of the peripheral driving circuit can be increased.

A second aspect of the present invention relates to an electronic-optical device including: an active matrix substrate having on the same plane a plurality of scanning lines, a plurality of signal lines provided to intersect the scanning lines, a plurality of pixel electrodes provided at the intersection portions of the scanning lines and the signal lines, and a peripheral driving circuit to matrix drive the pixel electrodes; a counter substrate, one surface thereof being provided with a common electrode over the entire surface thereof, facing the active matrix substrate such that the common electrode is opposite to the pixel electrodes; and a liquid crystal layer interposed between the active matrix substrate and the counter substrate. The counter substrate does not overlap with the peripheral driving circuit or with wiring lines to supply signals to the peripheral driving circuit in plan view.

According to the present invention, little or no parasitic capacitance occurs between the peripheral driving circuit and the common electrode. Furthermore, even if the peripheral driving circuit is driven at a high speed, a high display quality with a small signal distortion can be acquired.

Particularly, when the peripheral driving circuit, which is equipped with a thin film transistor having a channel region made of single crystal silicon and is capable of driving at a high speed at 10 MHz and more, is used, the aforementioned effect is large.

In addition, the peripheral driving circuit includes either a data line driving circuit or a sample hold circuit. The wiring lines preferably include at least one of a clock signal line, an image signal selecting line, and an image signal line.

Particularly, since the above-described peripheral driving circuit requires a high speed driving, there is a risk that serious signal distortion can occur due to parasitic capacitance generated between the peripheral driving circuit and the common electrode. Thus, a display quality can be greatly enhanced by making the common electrode not overlap with the peripheral driving circuit in plan view.

A third aspect of the present invention relates to a method of manufacturing an electro-optical device including: forming a plurality of pixel electrodes and a peripheral driving circuit to matrix drive the plurality of pixel electrodes on one surface of an active matrix substrate; forming a common electrode on one surface of a counter substrate over the entire surface thereof; removing a portion where the common electrode of the counter substrate overlaps with the peripheral driving circuit or with wiring lines to supply signals to the peripheral driving circuit in plan view; bonding the active matrix substrate to the counter substrate with a predetermined gap therebetween using a sealing material such that the common electrode is opposite to the pixel electrodes; and forming a liquid crystal layer by injecting liquid crystal into a space formed by the active matrix substrate, the counter substrate, and the sealing material.

According to the present invention, the generation of parasitic capacitance between the peripheral driving circuit and the common electrode can be easily reduced or prevented only by etching a portion of the common electrode. Thus, it is possible to follow the related art manufacturing process almost as is.

According to a fourth aspect of the present invention, an electronic apparatus is provided which is equipped with the aforementioned electro-optical device.

According to the present invention, it is possible to provide an electronic apparatus having an electro-optical device that is capable of displaying an image with small signal distortion and high quality.

### BRIEF DESCRIPTION OF THE DRAWINGS

FIG. 1 is a plan view of a liquid crystal device which is an example of an electro-optical device according to a first exemplary embodiment of the present invention;

FIG. 2 is a sectional view of the liquid crystal device which is an example of the electro-optical device according to the first exemplary embodiment of the present invention;

FIG. 3 is a schematic showing an electrical circuit configuration of the liquid crystal device which is an example of the electro-optical device according to the first exemplary embodiment of the present invention;

FIG. 4 is a plan view of a liquid crystal device which is an example of an electro-optical device according to a second exemplary embodiment of the present invention;

FIG. 5 is a sectional view of the liquid crystal device which is an example of the electro-optical device according to the second exemplary embodiment of the present invention;

FIG. 6 is a schematic showing a functional configuration of an electronic apparatus according to the present invention;

FIG. 7 is a sectional view showing a liquid crystal projector as an example of the electronic apparatus according to the present invention;

FIG. 8 is a front view showing a personal computer as another example of the electronic apparatus according to the present invention;

FIG. 9 is an exploded perspective view showing a pager as another example of the electronic apparatus according to the present invention; and

FIG. 10 is a perspective view showing a liquid crystal device using a TCP which is another example of the electronic apparatus according to the present invention.

### DETAILED DESCRIPTION OF PREFERRED EMBODIMENTS

(First Exemplary Embodiment)

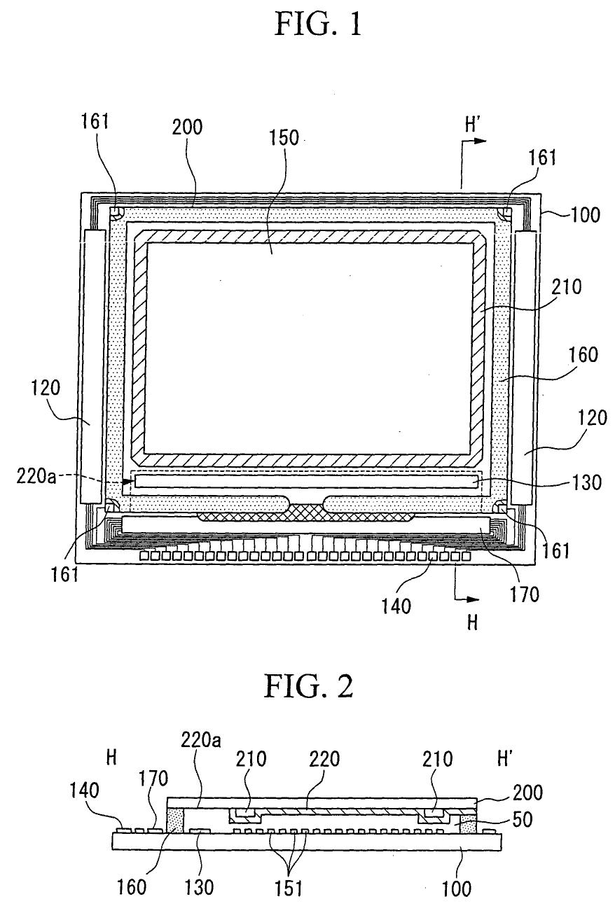

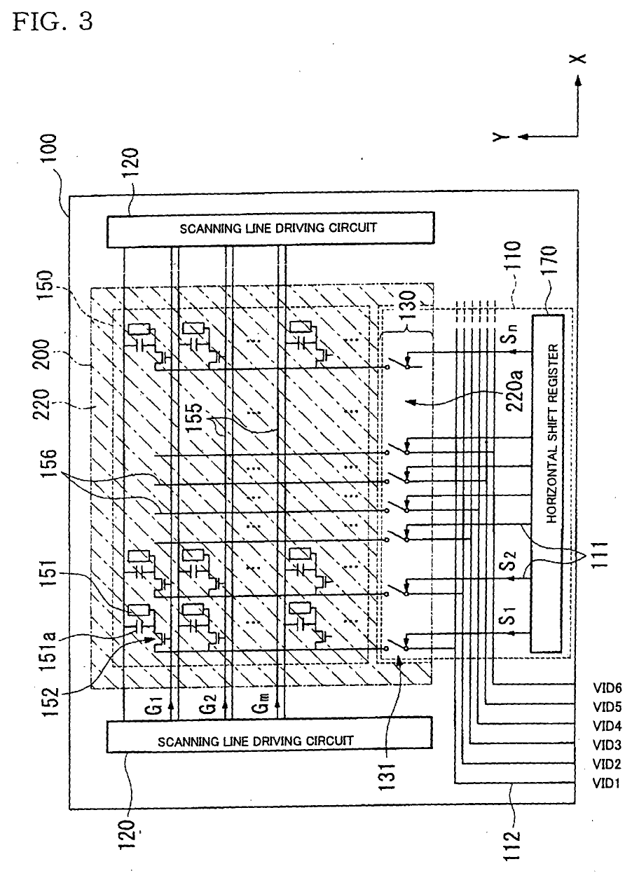

FIG. 1 is a plan view of an active matrix substrate of a liquid crystal device, which is an example of an electro-optical device according to a first exemplary embodiment, and components formed thereon as viewed from the side of the counter substrate. FIG. 2 is a cross-sectional view taken along plane H-H′ in FIG. 1 including the counter substrate. FIG. 3 is a schematic showing an electrical configuration of various wiring lines or peripheral circuits provided on the active matrix substrate.

The liquid crystal device of the present exemplary embodiment is configured as a peripheral circuit built-in type electro-optical device in which a peripheral driving circuit is integrally formed thereon. As shown in FIG. 3, a rectangular display region 150 is provided on the center of an active matrix substrate 100 made of hard glass or quartz, and a peripheral driving circuit, which includes a scanning line driving circuit 120, a data line driving circuit 110, and various wiring lines for supplying predetermined signals, such as clock signals or image signals, to these circuits 110 and 120, is provided in the circumference of the display region 150.

Herein, in the display region 150, a plurality of scanning lines 155 and signal lines 156 are formed in an X direction and in a Y direction, respectively. Pixel parts comprising TFTs (thin film transistors) 152 and rectangular pixel electrodes 151 are formed at the intersection portions of the scanning lines 155 and the signal lines 156. The gates and sources of the TFTs 152 are connected to the scanning lines 155 and the signal lines 156, respectively, and the drains of the TFTs are connected to the pixel electrodes 151. In addition, to enhance the maintenance characteristics, storage capacitors 151a are connected to the drains in parallel with the pixel electrodes 151.

The scanning line driving circuit 120 is mainly composed of a vertical shift register and sequentially applies scanning signals G1, G2, . . . , Gm in pulses to the scanning lines 155 based on a reference clock signal supplied from an external control device via a clock signal line (not shown) during one vertical scanning period of time.

The data driving circuit 110 includes a horizontal shift register 110, which sequentially supplies sampling driving signals S1, S2, . . . , Sn to each sampling driving signal line 111 based on the reference clock supplied from the external control device via the clock signal line, and a sample hold circuit 130, which samples image signals VID1 to VID6 supplied via the image signal lines 112.

The sample hold circuit 130 includes sampling switches (TFTs) 131 which are provided at every signal line. When sampling driving signals S1, S2, . . . , Sn are inputted from the horizontal shift register 110, each sampling switch 131 sequentially applies image signals VID1 to VID6, which are sampled for each of the six image signal lines 112, to every group including six adjacent signal lines 156. Thus, for one horizontal scanning period of time (i.e., a period for a scanning signal to be supplied to one scanning line 155 by a scanning line driving circuit 120), the sampled image signal is supplied to each signal line 156.

Furthermore, as shown in FIG. 1, mounting terminals 140 to mount an external control device is provided in the end of the lower side of the active matrix substrate 100. Various kinds of signals are supplied from the external control device to the scanning line driving circuit 120 and the data line driving circuit 110 via the mounting terminals 140.

In addition, an alignment film (not shown) made of polyimide and the like is formed on the active matrix substrate 100 configured as described above, and the sealing material 160 is coated in a rectangular frame pattern to surround the display region 150.

Moreover, TFTs constituting the aforementioned peripheral driving circuits and TFTs 152 constituting the respective pixel parts of the display region 150 are manufactured by the same process. In addition, in order to enhance the driving performance, single crystal silicon is used for a channel region of the TFT. For example, the single crystal silicon is formed on the active matrix substrate 100 by the SOI (Silicon on Insulator) technique. Thus, it is possible to cope with a high speed driving at several tens to several hundreds of MHz by using the single crystal silicon of a high charge mobility in the channel region of the TFT.

In addition, the arrangement of these circuits 110 and 120 is defined such that the display quality can be enhanced to the maximum when the size of the active matrix substrate is constant. For instance, as shown in FIG. 1, the horizontal register 170 of the data line driving circuit 110 and the scanning line driving circuit 120, which are driven by voltages including DC components, are arranged in regions that do not face liquid crystal (that is, the outside of the sealing material frame). Thus, it is possible to reduce or prevent the degradation of the liquid crystal layer 50 due to the DC voltage leakage from these circuits to the liquid crystal layer 50.

In addition, the sample hold circuit 130, which is driven by AC voltage from the counter electrode potential, is provided within the range of the sealing material 160, and the sealing material 160 is provided between the sample hold circuit 130 and the horizontal shift register 170. By such arrangement, when the substrates 100 and 200 are bonded to each other, the possibility of the sealing material 160 being spread into the display region 150 due to the compression of the sealing material 160 becomes smaller. Thus, it is possible to reduce the seal width margin. By such a constitution, it is possible to reduce the size of the active matrix substrate 100 and manufacturing costs. In addition, since the output signal voltage of the sample hold circuit 130 does not contain a DC component with respect to the potential of the light shielding film 210 and the common electrode 220, which are provided above the liquid crystal, the liquid crystal is not degraded by a leaked voltage.

Meanwhile, as shown in FIGS. 1 and 2, in the inner side (the side of liquid crystal layer 50) of the counter substrate 200 made of glass and the like, a light shielding film (peripheral partition) 210 made of a metal material, such as Cr (chromium), Ni (nickel), and Al (aluminum), is formed in a rectangular frame pattern around the circumference of the display region 150. Furthermore, a transparent common electrode 220 made of ITO and the like is formed to cover the light shielding film 210 and the substrate surface.

The light shielding film 210 and the common electrode 220 are arranged such that they cannot overlap in plan view with the data line driving circuit 110, which undergoes a high speed driving, or the sampling driving signal lines (image signal selecting lines) 111, the clock signal lines (not shown), and the image signal line 112, which supply various signals to the data line driving circuit 110.

For instance, the lower side of the light shielding film 210 is arranged in the display region 150 rather than the data line driving circuit 110 and the various wiring lines in plan view. When the sample hold circuit 130 is arranged to get most adjacent to the display region 150 among the data line driving circuit 110 and the various wires, the lower side of the light shielding film 210 is arranged between the sample hold circuit 130 and the display region 150 in plan view. In contrast, in the common electrode 220, the electrode surface of the common electrode 220a, which overlaps with the data line driving circuit 110 and with the various wiring lines, is removed in plan view.

As described above, since a conductive material, such as the light shielding film 210 or the common electrode 220, is not provided in a position facing the peripheral driving circuit in which high speed driving is performed, the generation of parasitic capacitance between the conductive material and the peripheral driving circuit can be reduced or prevented in advance, thereby acquiring a high quality display with small signal distortion. In addition, the common electrode 220 of the counter substrate 200 can be obtained, for example, by forming the light shielding film 210 on the counter substrate 200, thereafter forming a transparent electrode made of ITO on the entire surface of the substrate, and removing a portion, that overlaps with the data line driving circuit 110 in plan view, using etching.

The counter substrate 200 is bonded to the active matrix substrate 100 by the sealing material 160, and the gap between the substrates is kept constant by spacers (not shown), which are dispersed into the sealing material 160. And, the liquid crystal is injected into a space formed by the sealing material 160 and the substrates 100 and 200 to form a liquid crystal layer 50. In addition, the active matrix substrate 100 is electrically connected to the counter substrate 200 by one conductive material 161 provided in at least one of the four corners of the sealing material 160.

In the above construction, when a scan signal Gm is supplied to any scanning line 155 from an outside control device, all the TFTs 152 connected to the scan line 155 are turned on. Simultaneously, six parallel image signals VID1 to VID6 supplied from the image signal lines 112 are sampled by the sample hold circuit 130. Next, when the sampling driving signals S1, S2, . . . , Sn are sequentially supplied, the sampled image signals VID1 to VID6 are written in the liquid crystal layer 50 corresponding to the TFT, which is in on state, and then these signals are maintained during a predetermined period of time. At this time, since the orientation order of liquid crystal molecules changes in accordance with the voltage level applied to the liquid crystal layer 50 of each pixel, gradation display is performed by the light modulation.

According to the electro-optical device of the present invention, since the generation of parasitic capacitance between the peripheral driving circuit, which requires high speed driving like the data line driving circuit 110, and the various wiring lines for supplying signals to the peripheral line driving circuit, and the common electrode 220 does not occur, it is possible to reduce the distortion of a signal and to obtain a high quality display even if the peripheral driving circuit is driven at a high speed. In addition, since the parasitic capacitance is not generated only by removing a portion of the common electrode 220 facing the peripheral driving circuit and the like, the degree of freedom of the alignment of the peripheral driving circuit can be increased.

In addition, the generation of parasitic capacitance can be easily reduced or prevented only by etching a portion of the common electrode 220 formed on the entire surface of counter substrate 200 (a portion which overlaps with the peripheral driving circuit in plan view). Thus, it is possible to follow the related art manufacturing process almost as is.

(Second Exemplary Embodiment)

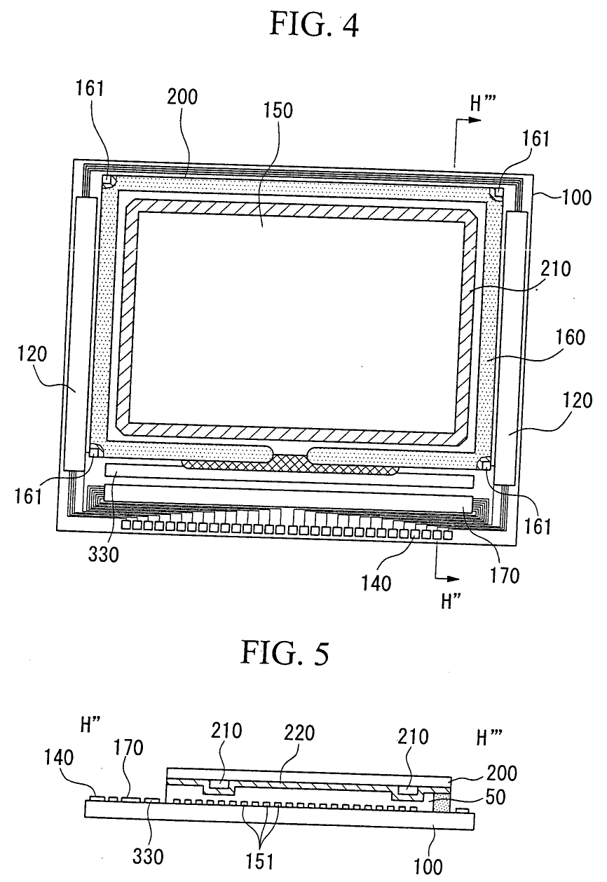

FIG. 4 is a plan view of an active matrix substrate of a liquid crystal device, which is an example of an electro-optical device according to a second exemplary embodiment, along with components formed thereon as viewed from the side of the counter substrate. FIG. 5 is a cross-sectional view taken along plane H″-H″″ in FIG. 3 including the counter substrate.

In FIG. 4 and FIG. 5, the same reference numbers are used to the same constitutions of FIG. 1 and FIG. 2.

In the liquid crystal device according to the present exemplary embodiment, basic constitutions are the same as those of the first exemplary embodiment of FIG. 1 and FIG. 2. However, this exemplary embodiment is provided such that the lower side of the light shielding film 210 is arranged in the display region 150 rather than in the data line driving circuit 110 and the various wiring lines in plan view such that the light shielding film 210 and the common electrode 220 do not overlap, in plan view, with the data line driving circuit 110, which undergoes high speed driving, or the clock signal lines, the sampling driving signal lines (image signal selecting line) 111, and the image signal lines 112, which supply various signals to the data line driving circuit 110.

For instance, when the sample hold circuit 330 is arranged to get most adjacent to the display region 150 among the data line driving circuit 110 and the various wires, the lower sides of the light shielding film 210 and the counter substrate 200 are provided between the sample hold circuit 330 and the display region 150 in plan view. In this case, it is preferable that the gap between the display region 150 and the sample hold circuit 330 be set somewhat widely so that the bonding accuracy between the active matrix substrate 100 and the counter substrate 200 can be secured by ±1 μm.

As described above, since a conductive material, such as the light shielding film 210 or common electrode 220, is not provided at a position facing the, peripheral driving circuit in which high speed driving is performed, the occurrence of parasitic capacitance between the conductive material and the peripheral driving circuit can be reduced or prevented in advance. Thus, it is possible to obtain a high quality display having small signal distortion.

According to the electro-optical device of the present invention, the generation of the parasitic capacitance between the peripheral driving circuit, which requires high speed driving like the data line driving circuit 110, and various wiring lines to supply signals to the peripheral driving circuit, and common electrodes 220 is reduced or prevented. Thus, the distortion of a signal is reduced and a high quality display is acquired even if the peripheral driving circuit is driven at a high speed.

In addition, according to the present exemplary embodiment, the generation of parasitic capacitance can be easily reduced or prevented only by correcting the arrangement of the peripheral circuit to get out of the way. Thus, it is possible to follow the related art manufacturing process almost as is.

(Exemplary Electronic Apparatus)

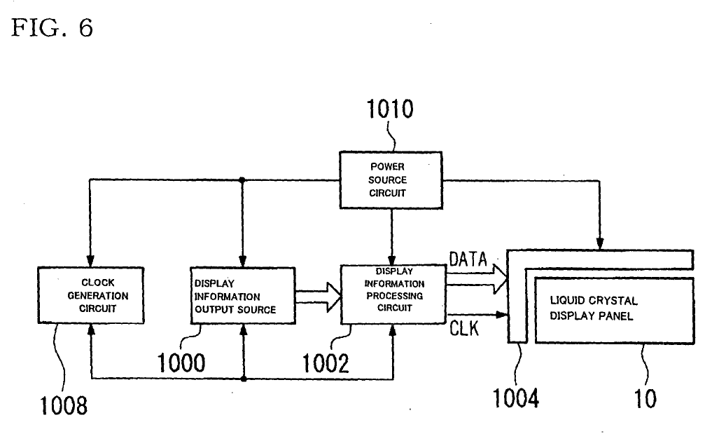

An exemplary embodiment of the electronic apparatus equipped with the electro-optical device as described above in detail, is described below with reference to FIGS. 6 to 10.

First, FIG. 6 shows an outline construction of an electronic apparatus equipped with the electro-optical device.

Referring to FIG. 6, the electronic apparatus includes a display information output source 1000, a display information processing circuit 1002, a liquid crystal panel 10 as a previously described electro-optical device, a clock generation circuit 1008, and a power source circuit 1010.

The display information output source 1000 includes a memory, such as ROM (Read Only Memory), RAM (Random Access Memory), and an optical disk apparatus, and a resonant circuit, and outputs to a display information processing circuit 1002 display information, such as image signals in a predetermined format, based on the clock signals from the clock generation circuit 1008. The display information processing circuit 1002 includes a related art processing circuits, such as an amplifying and polarity-inverting circuit, a phase expansion circuit, a rotation circuit, a gamma correction circuit, and a clamp circuit. The display information processing circuit 1002 generates digital signals sequentially from the inputted display information based on the clock signals, and outputs the digital signals together with clock signals CLK to the driving circuit 1004.

The driving circuit 1004 drives the liquid crystal panel 10 through the previously described driving method by the scanning line driving circuit 120 and the data line driving circuit 110. The power source circuit 1010 supplies each of the aforementioned circuits with a predetermined voltage. Furthermore, the driving circuit 1004 may be mounted on the TFT array substrate constituting the liquid crystal panel 10, and in addition, the display information processing circuit 1002 may be mounted on the TFT array substrate constituting the liquid crystal panel 10.

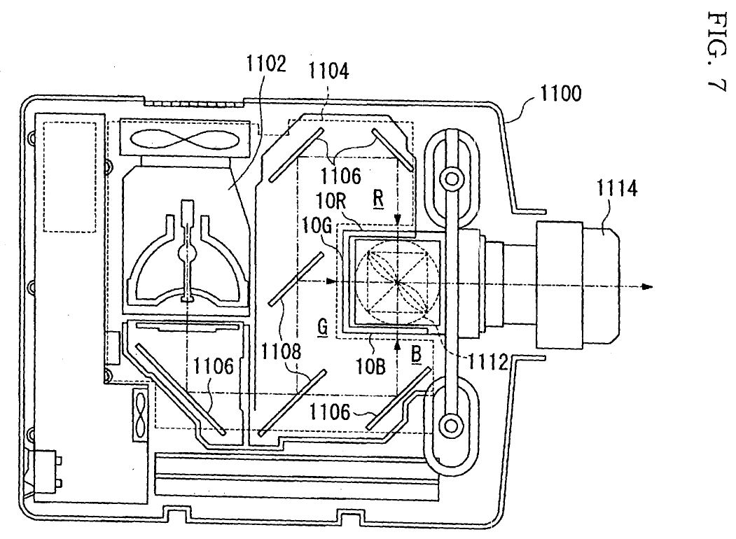

Next, specific examples of the electronic apparatus like this construction are described with reference to FIGS. 7 to 10.

FIG. 7 is a cross-sectional view illustrating an example of a liquid crystal projector. The liquid crystal projector 1100 is constructed as a projection type projector equipped with the previously described electro-optical device 10 as light valves 10R, 10G, and 10B for RGB. In the liquid crystal projector 1100, white light projected from a lamp unit 1102 of the white light source is led to a plurality of mirrors 1106 inside of a light guide 1104 and then can be divided into R, G, and B light components corresponding to the three primary colors of RGB by two dichroic mirrors 1108. Then, these light components R, G, and B are modulated by the light valves 10R, 10G, and 10B corresponding the respective light components R, G, and B, and composed again by a dichroic prism 1112. Then, the composed light is projected to the screen through a projection lens 1114.

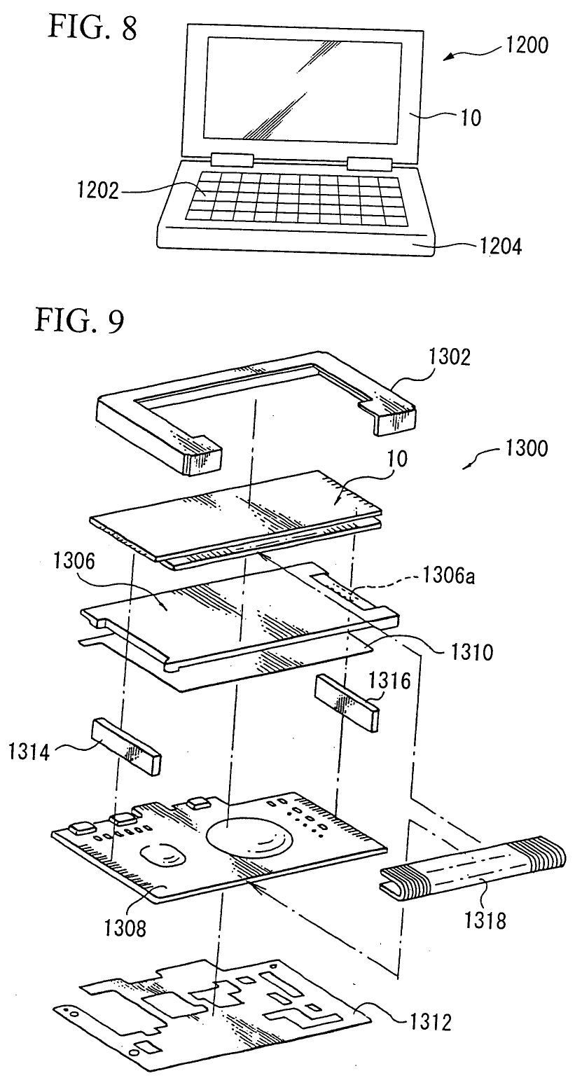

FIG. 8 is a front view showing an example of a laptop type personal computer. The personal computer 1200 is equipped with a CPU, a memory, a modem, and a keyboard 1202 at a main body 1204 and also equipped with the electro-optical device 10 as a display unit within a top cover case.

FIG. 9 is an exploded perspective view showing an example of a pager.

A pager 1300 is equipped with the electro-optical device 10 as a display unit, and the electro-optical device 10 is accommodated within a metal frame 1302 together with a light guide 1306 including a backlight 1306a, a circuit substrate 1308, a first and second shield plates 1310 and 1312, two resilient conductors 1314 and 1316, and a film carrier tape 1318.

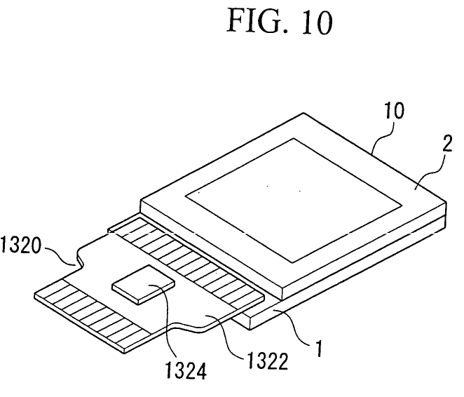

Furthermore, as shown in FIG. 10, in the pager 1300, a circuit part may be attached at the outside, and for example, in such a pager, a TCP (Tape Carrier Package) 1320, in which an IC 1324 including a display information processing circuit 1002 is mounted on a polyimide tape 1322, is connected to an active matrix substrate 1 physically or electrically through an anisotropic conductive film.

Moreover, in addition to the electronic apparatuses shown in FIGS. 7 to 10, the electro-optical device according to the present exemplary embodiment can be used to a liquid crystal television, a view finder type or a monitor direct viewing type video tape recorder, a car navigation apparatus, an electronic organizer, an electronic calculator, a word processor, a workstation, a mobile phone, a television phone, a POS terminal, apparatuses equipped with touch panel, etc., as a display unit.

Accordingly, since the electronic apparatus of the present invention has the electro-optical device according to the above exemplary embodiment as a display unit, it is possible to realize an electronic apparatus having a display unit that is capable of displaying an image with small signal distortion and high quality.

Furthermore, the present invention is not limited to the above exemplary embodiments and may be modified and realized variously without departing from the spirit and scope of the present invention.

For instance, a pre-charge circuit 120 may be formed on the active matrix substrate 100 other than the scanning line driving circuit 120, the data line driving circuit 110, and the sample hold circuits 130 and 330. The pre-charge circuit 120 pre-charges the signal lines 156 to a predetermined potential at the timing precedent to the sampling of image signals in order to reduce the writing load of image signals to the signal lines 156 of the data line driving circuit and functions as a supplementary circuit of the data line driving circuit. The pre-charge circuit requires a high speed driving like the sample-hold circuits 130 and 330. Thus, when the pre-charge circuit is formed on the active matrix substrate 100, it is preferable that the portion, where the pre-charge circuit or the pre-charge signal lines for supplying signals to the pre-charge circuit overlap with the common electrode 220 of the counter substrate 200 in plan view, be removed by etching.

Furthermore, in this exemplary embodiment, only a portion of the common electrode 220, which faces the peripheral driving circuit, is removed, but all of the common electrode with no contribution for display (i.e., a region except for the display region 150) may be removed. However, in this case, it is necessary to secure an electrode portion in order to electrically connect the active matrix substrate 100 to the counter substrate 200 using a conductive member 106.

In addition, this exemplary embodiment drives scanning lines 155 using two scanning line driving circuits 120 from both sides. However, when the delay of the scanning signals supplied to the scan lines 155 is a small matter, the scanning line driving circuit 120 of one side may be omitted, and then the scan lines 155 may be driven only by the other scanning line driving circuit 120.

Moreover, color filters are mounted on the counter substrate 200 according to the use of the electro-optical device, and a light shielding film made of a metal material, such as Cr (chromium), Ni (nickel), and Al (aluminum), or made of resin black, in which C (carbon) or Ti (titanium) is dispersed in a photoresist, is provided between the adjacent color filters. Furthermore, when the electro-optical device is used as a color light modulation element of a light valve of a projector, a light shielding film is formed on the counter substrate 200 without the color filters. Also, a front light or a backlight for irradiating light to the electro-optical device may be provided as the occasion demands.

Furthermore, besides TN liquid crystal and STN liquid crystal, in which an initial alignment state is controlled by an alignment film, polymer dispersed liquid crystal, in which liquid crystal molecules are dispersed to make their alignment states random, may be used in the liquid crystal layer 50 of the electro-optical device. Moreover, the above description describes the electro-optical device as a liquid crystal device, but the present invention is not limited to the above exemplary embodiments. The present invention can be also applied to an electro-optical device, which uses an electro-luminescence (EL) device, a digital micro mirror device (DMD), or various electro-optical elements using plasma light emitting or fluorescence due to electron emission, and to an electronic apparatus equipped with the electro-optical device.

What is claimed is:

1. An electro-optical device, comprising:
an active matrix substrate having on the same plane a plurality of scanning lines, a plurality of signal lines provided to intersect the scanning lines, a plurality of pixel electrodes provided at the intersection portions of the scanning lines and the signal lines, and a peripheral driving circuit to matrix drive the pixel electrodes;
a counter substrate having a common electrode on one surface and facing the active matrix substrate such that the common electrode is opposite to the pixel electrodes; and
a liquid crystal layer interposed between the active matrix substrate and the counter substrate;
a portion, where the common electrode overlaps with the peripheral driving circuit or with wiring lines to supply signals to the peripheral driving circuit in plan view, being removed.

2. An electro-optical device, comprising:
an active matrix substrate having on the same plane a plurality of scanning lines, a plurality of signal lines provided to intersect the scanning lines, a plurality of pixel electrodes provided at the intersection portions of the scanning lines and the signal lines, and a peripheral driving circuit to matrix drive the pixel electrodes;
a counter substrate, one surface thereof being provided with a common electrode over the entire surface thereof, facing the active matrix substrate such that the common electrode is opposite to the pixel electrodes; and
a liquid crystal layer interposed between the active matrix substrate and the counter substrate;
the counter substrate being provided so as to not overlap with the peripheral driving circuit or with wiring lines to supply signals to the peripheral driving circuit in plan view.

3. The electro-optical device according to claim 1, the peripheral driving circuit being equipped with thin film transistors having channel regions made of single crystal silicon.

4. The electro-optical device according to claim 1, the frequency of at least one of driving signals inputted into the peripheral driving circuit being equal to or more than 10 MHz.

5. The electro-optical device according to claim 1, the peripheral driving circuit including at least one of a data line driving circuit and a sample hold circuit, and the wiring lines including at least one of clock signal lines, image signal selecting lines, and image signal lines.

6. A method of manufacturing an electro-optical device, comprising:
forming a plurality of pixel electrodes and a peripheral driving circuit to matrix drive the plurality of pixel electrodes on one surface of an active matrix substrate;
forming a common electrode on one surface of a counter substrate over the entire surface thereof;
removing a portion where the common electrode of the counter substrate overlaps with the peripheral driving circuit or with wiring lines for supplying signals to the peripheral driving circuit in plan view;
bonding the active matrix substrate to the counter substrate with a predetermined gap therebetween using a sealing material such that the common electrode is opposite to the pixel electrodes; and
forming a liquid crystal layer by injecting liquid crystal into a space formed by the active matrix substrate, the counter substrate, and the sealing material.

7. An electronic apparatus, comprising:
the electro-optical device according to claim 1.
